(19) United States
(12) Patent Application Publication
(10) Pub. No.: US 2008/0041714 A1
(43) Pub. Date: Feb. 21, 2008

(54) Partially Oxidized Macroporous Silicon with Discontinuous Silicon Walls

(75) Inventors: Stephan Dertinger, Munich (DE); Marco Kluehr, Munich (DE)

Correspondence Address: DICKSTEIN SHAPIRO, LLP, 1177 AVENUE OF THE AMERICAS, NEW YORK, NY, 10036-2714, US

(73) Assignee: Qimonda AG, Munich (DE)

(21) Appl. No.: 11/568,113

(22) PCT Filed: Mar. 7, 2005
(86) PCT No.: PCT/EP05/02390

§ 371 Date: Jan. 17, 2007

(30) Foreign Application Priority Data
Apr. 19, 2004 (DE) 10 2004 018 846.7

(51) Int. Cl. B01J 19/08; B01J 19/00; B01L 9/00; C25F 3/02

(52) U.S. Cl. 204/157.15; 216/56; 422/104; 422/50

(57) ABSTRACT

A device and method for producing a “biochip base module” for detecting biochemical reactions for the study of enzymatic reactions, nucleic acid hybridizations, protein-protein interactions and other binding reactions in the field of genome, proteome, or active-agent research. A flat macroporous support material having a multiplicity of 500 nm to 100 μm diameter pores distributed over at least one surface region and extending from one surface through to the opposite surface of the support material. The device has two or more regions having pores with SiO₂ pore walls. These regions are each surrounded by a frame or box of walls with a silicon core arranged parallel to the longitudinal axes of the pores and is open towards the surfaces. The silicon core merges into silicon dioxide over the cross section towards the outer side of the walls forming the frame, and each individual frame is spatially isolated from the frames surrounding it.

### CROSS-REFERENCE TO RELATED APPLICATION

This application is a national phase of International Patent Application Serial No. PCT/EP2005/002390, filed Mar. 7, 2005, which published in German on Oct. 27, 2005 as WO 2005/100994, and is incorporated herein by reference in its entirety.

### FIELD OF THE INVENTION

A biochip base module according to the invention is a suitable basis for a “biochip base module” in methods for detecting biochemical (binding) reactions and, in this context, in particular for the study of enzymatic reactions, nucleic acid hybridizations, protein-protein interactions and other binding reactions in the field of genome, proteome or active-agent research in biology and medicine.

### BACKGROUND OF THE INVENTION

In molecular biology, increasing use is being made of biochips with which discoveries about organisms and tissue can be made in a rapid fashion. The detection of (bio)chemical reactions, that is to say the detection of biologically relevant molecules in a defined study material, is extremely important for the biosciences and medical diagnosis. In this scope, the development of so-called biochips is being constantly pursued. Such biochips are usually miniaturized hybrid functional elements with biological and technical components, in particular biomolecules which are immobilized on a surface of a biochip base module and are used as specific interaction partners. The structure of these functional elements often has rows and columns. The term “microarrays” is then used. Since thousands of biological or biochemical functional elements can be arranged on one chip, they generally need to be fabricated using microtechnological methods.

Particularly suitable as biological and biochemical functional elements are: DNA, RNA, PNA, (in the case of nucleic acids and chemical derivatives thereof, there may for example be single strands, triplex structures or combination thereof present), saccharides, peptides, proteins (for example antibodies, antigens, receptors), derivatives from combinatorial chemistry (for example organic molecules), cell components (for example organelles), cells, multicellular organisms, cell groups.

Many of the analytical methods currently used in active-agent research and clinical diagnosis employ optical methods for the detection of binding events between a substance to be detected and capture molecules (for example DNA hybridizations, antigen-antigen interactions and protein interactions). The substance to be detected is in this case provided with a marker which fluoresces after excitation with light of a suitable wavelength (fluorescence method) or which initiates a chemical reaction that in turn produces light (chemiluminescence method). When the substance to be detected, that is to say the target molecule, binds with the immobilized capture molecule on the surface, then this can be detected optically, for example by means of luminescence. The term “luminescence” is in this case intended to mean the spontaneous emission of photons in the ultraviolet to infrared spectral range. The luminescent excitation mechanisms may be optical or non-optical in nature, for example electrical, chemical, biochemical and/or thermal excitation processes. Therefore, in particular, chemi-, bio- and electro-luminescence as well as fluorescence and phosphorescence are intended to be covered by the term “luminescence” in the scope of this invention.

Porous substrates with a high optical density and low reflectivity, for example porous silicon whose reflectivity is 50 to 70% in the visible range of the spectrum, however, do not give the expected results in conjunction with fluorescence or chemiluminescence methods in so far as the experimentally observed light-signal yield falls far short of the theoretically achievable values. The reasons for reduced experimentally determined light-signal yields compared with the theoretical values when such porous substrates are used are, on the one hand, problems with emitting the fluorescence of the substance or binding to be studied, and on the other hand—when a fluorescence method is used—problems with the optically exciting the fluorescence.

If (luminescent) light is produced throughout the volume of the pores, then the reflectivity of the pore walls is a crucial factor with a view to effective delivery of the optical signal to the surface. In the case of chemiluminescence, the light signal is radiated isotropically in all directions of space. Consequently, only a very small proportion of the generated light radiates directly in the aperture angle of the individual pore. All other optical paths are reflected several times by the walls of the pores before they reach the opening of the pore in question. Even with reflectivities which are only a little less than 100%, however, the intensity of a signal will be greatly reduced after multiple reflections. This means that this proportion of the generated signal will be greatly attenuated on its way out of the pore, and can then scarcely make any contribution to the overall signal.

Attenuation due to multiple reflections by the pore walls when exciting and emitting fluorescence furthermore constitutes a serious problem. Only fluorophors (fluorescent substances in the analyte) which radiate directly towards the pore opening are available unattenuated for a fluorescence signal. All the other optical paths are reflected at least once by the walls of the pores before they reach the opening of the pore. Even with reflectivities which are only a little less than 100%, these multiple reflections will lead to a significant attenuation of the optical signal to be detected.

In order to resolve the aforementioned problems of intensity attenuation due to multiple reflections, it has been proposed to arrange reflection layers on the pore walls in order to reduce the reflection losses, so that the excitation and emission light can delivered better from the pores. But this solution approach does not lead to any significant improvement of the signal yield.

WO 03/089925 presents a 3D waveguide structure having locally transparent regions made of SiO₂, said transparent regions in turn being surrounded by a reflective frame of walls with a silicon core, whereby it is possible to prevent the optical crosstalk of the luminescent light generated in the structure between the compartments by means of the reflective walls made essentially of silicon. Although the device presented in WO 03/089925 exhibits an improved absolute signal yield with an improved signal-to-noise ratio in the context of analysis methods based on fluorescence or chemiluminescence, the production of the 3D waveguide structure presented in WO 03/089925 can be controlled only with difficulty since severe stresses arise within the structure during the thermal oxidation of the macroporous silicon due to the volume doubling in the transition from silicon to silicon dioxide. In the worst-case scenario, this leads to flexure and distortion of the structure. However, such nonplanar substrates are unsuitable for biochips.

### SUMMARY OF THE INVENTION

A device including a substantially flat silicon based macroporous support material the support material having a first surface and a second surface opposite the first surface, a plurality of pores in the support material, the pores having a diameter from about 500 nm to about 100 μm and extending from the first surface of the support material to the second surface of the support material, and at least two regions. Each region includes at least one pore with SiO₂ pore walls, a frame of walls surrounding the at least one pore with SiO₂ pore walls, wherein the walls have a silicon core and are arranged substantially parallel to a longitudinal axes of the pores, and the silicon core merges into silicon dioxide over a cross section towards an outer side of the walls forming the frame, and at least one pore separating each frame from each region such that each of the frame of walls with a silicon core is spatially isolated from each other frame of walls with a silicon core.

### BRIEF DESCRIPTION OF THE DRAWINGS

The present invention will be described by way of example below with reference to the figures.

FIG. 1 shows a schematic view of a device presented in WO 03/089925;

FIG. 2 shows a schematic view of an exemplary embodiment of a device according to the invention;

FIG. 3 shows a schematic view of a further exemplary embodiment of a device according to the invention; and

FIG. 4 shows a schematic view of yet another exemplary embodiment of a device according to the invention.

### DETAILED DESCRIPTION OF THE INVENTION

The present invention relates to a device including a flatly designed macroporous support material based on silicon, which has a multiplicity of pores with a diameter in the range of from 500 nm to 100 μm distributed over at least one surface region and extending from one surface (10A) through to the opposite surface (10B) of the support material, wherein the device has two or more regions (11A) which in each case comprise two or more pores with SiO₂ pore walls, and wherein these regions are surrounded in each case by a frame or box (12) of walls with a silicon core (12A) which is arranged essentially parallel to the longitudinal axes of the pores and is open towards the surfaces (10A, 10B), wherein the silicon core merges into silicon dioxide over the cross section towards the outer side of the walls forming the frame, and wherein each individual frame (12) within the totality of all the frames of walls with a silicon core (12A) is completely spatially isolated from the frames surrounding or adjacent to it, and to a method for producing it.

So-called microarrays are the most widespread variant of biochips. They are small wafers (“chips”) for example of glass, gold, plastic or silicon. In order to detect corresponding biological or biochemical (binding) reactions, for example, small amounts of various solubilized capture molecules, for example a known nucleic acid sequence, are fixed on the surface of the biochip base module in the form of very small droplets, so-called dots, in a point-like and matricial fashion.

In practice, a few hundred to a few thousand droplets are used per chip. An analyte to be studied, which may for example contain fluorescence-labeled target molecules, is then pumped over this surface. This generally leads to various chemical (binding) reactions between the target molecules contained in the analyte and the fixed or immobilized capture molecules. As mentioned above, the target molecules are labeled with dyestuff molecule components, usually fluorochromes, in order to observe these reactions or bindings. The presence and the intensity of light which is emitted by the fluorochromes provides information about the progress of the reaction or binding in the individual droplets on the substrate, so that conclusions can be drawn about the presence and/or the property of the target molecules and/or capture molecules. When the corresponding fluorescence-labeled target molecules of the analyte react with or bind to the capture molecules immobilized on the surface of the support substrate, this reaction or binding can be detected by optical excitation with a laser and measurement of the corresponding fluorescence signal.

Substrates with a high but defined porosity have many advantages over planar substrates as a basis for such biochips. More detection reactions can take place on the greatly enlarged surface area. This increases the detection sensitivity for biological assays. When the target molecules dissolved in the analyte are pumped through the channels between the front and back sides of the porous substrate, they are brought in close spatial contact with the surface of the substrate (<10 μm). On this size scale, diffusion is a very effective transport process which quickly covers the distance between a target molecule to be detected and the capture molecules immobilized on the surface. The rate of the binding reaction can thereby be increased so that the duration of the detection method can be significantly shortened.

Electrochemically produced porous silicon is an example of a substrate with such a defined porosity (cf. DE 42 02 454, EP 0 553 465 or DE 198 20 756).

In particular, a device is provided which comprises a flatly designed macroporous support material (10) based on silicon, which has a multiplicity of periodically arranged discrete pores (11) with a diameter in the range of from 500 nm to 100 μm distributed over at least one surface region and extending from one surface (10A) through to the opposite surface (10B) of the support material, wherein the device has two or more regions (11A) which comprise in each case two or more pores with SiO₂ pore walls, and wherein these regions are surrounded in each case by a frame or box (12) of walls with a silicon core (12A) which is arranged essentially parallel to the longitudinal axes of the pores and is open towards the surfaces (10A, 10B), wherein the silicon core merges into silicon dioxide over the cross section towards the outer side of the walls forming the frame, and wherein each individual frame (12) within the totality of all the frames of walls with a silicon core (12A) is completely spatially isolated from the frames surrounding or adjacent to it.

The device according to the invention has SiO₂ regions which are locally oxidized fully, that is to say regions which comprise a plurality of pores with SiO₂ pore walls. These fully oxidized regions are in turn surrounded by a boxlike or framelike superstructure. The fully oxidized regions are framed or surrounded by walls made essentially of silicon, so that these walls made essentially of silicon form a frame or box or cylinder which is open towards the surfaces (10A, 10B), whose cylinder axis extends parallel to the pores and which surrounds or encloses the SiO₂ regions which are locally oxidized fully. The walls forming the frame have a silicon core, and, as viewed over a cross section extending in the surface plane of the support material, the silicon merges into silicon dioxide towards the outer side of the walls.

According to the present invention, each individual frame (12) within the totality of all the frames of walls with a silicon core (12A) is completely spatially isolated from the frames surrounding it or the adjacent frames. Consequently, the silicon walls of the individual regions or compartments are discontinuous or do not touch one another, but rather are completely separated from one another by means of regions with pore walls made of SiO₂. This structural arrangement according to the invention results in a spatial decoupling of the stresses that arise locally in the course of producing such a device due to the volume doubling in the transition from silicon to silicon dioxide. In the fully oxidized regions, the walls between the pores are made entirely of SiO₂. These regions or compartments are therefore transparent for wavelengths especially in the visible range. The device according to the invention therefore has locally transparent SiO₂ regions, and these transparent regions are in turn surrounded by a reflective frame of walls with a silicon core. In other words there are locally fully transparent SiO₂ regions or compartments, which are separated from one another by non-transparent walls with a silicon core that substantially form a boxlike secondary structure surrounding these compartments completely in the device according to the invention.

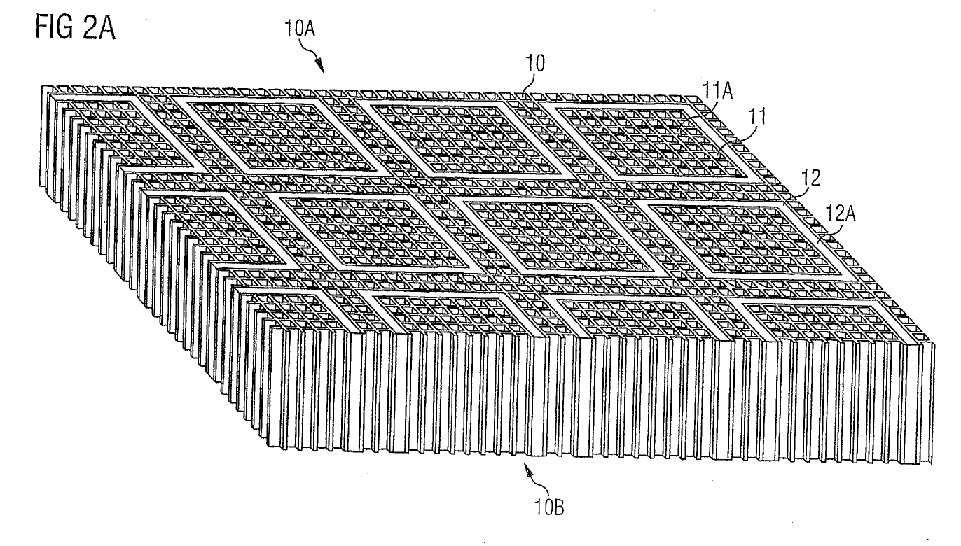

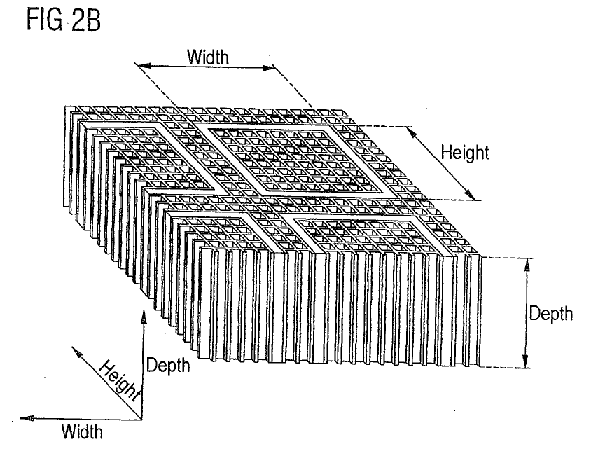

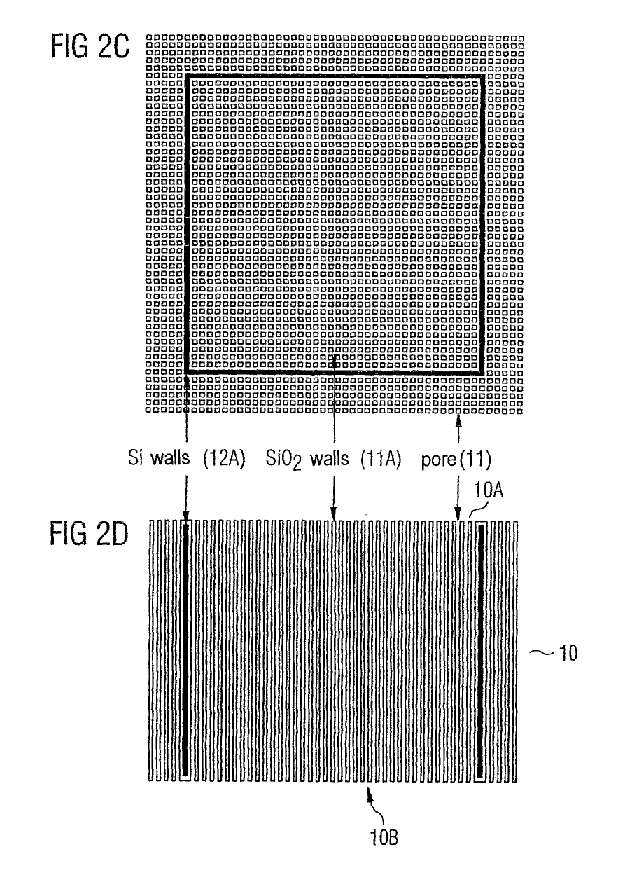

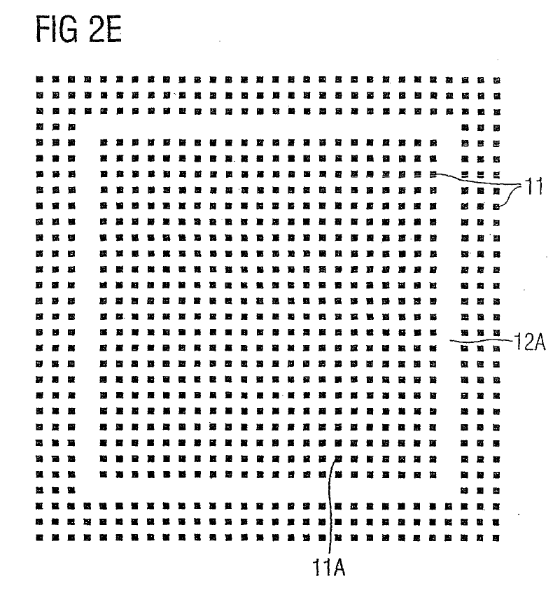

In the context of the present invention, the silicon frame of the compartments may have an aspect ratio of approximately 1:1:100 to 1:1:1 (height×width×depth); see FIG. 2(B).

The frame or box (12) of walls with a silicon core, which merges into silicon dioxide towards each of the two outer sides, eliminates scattered light and optical crosstalk between the regions or compartments which comprise two or more pores with SiO₂ pore walls. This is a substantial advantage over porous substrates which are fully transparent (for example SiO₂, glass chips or Al₂O₃).

In the device according to the invention a multiplicity of pores, usually arranged periodically, are arranged distributed over at least one surface region of the flatly designed macroporous support material (10) and extend from one surface (10A) to the opposite surface (10B) of the support material. Blind holes, that is to say pores which are open only towards one of the surface sides (10A, 10B), may also be locally provided on the flatly designed macroporous support material (10) in the scope of the present invention.

The macroporous support material which is used usually has a pore diameter of from 1 μm to 99 μm, preferably from 1 to 11 μm. The thickness of the macroporous support material is usually from 100 to 1000 μm, preferably from 250 to 450 μm. The spacing from pore centre to the pore centre (pitch), that is to say of two mutually neighbouring or adjacent pores, is usually from 1 to 100 μm, preferably from 2 to 12 μm. The pore density is usually in the range of from 10⁴ to 10⁸/cm².

The pores (11) in the device according to the invention may, for example, be configured essentially round or elliptically. In a preferred embodiment of the present invention, the pores (11) with SiO₂ pore walls are designed essentially squarely. The frame (12) of walls with a silicon core (12A) may then be in an essentially square or rectangular shape.

A device with a so-called hybrid structure which is constructed from continuous compartments and discontinuous compartments is also included in the context of the present invention (see FIG. 5).

The device according to the invention can be provided by a method, comprising the following steps:
(a) preparing a support material made of silicon with the surfaces (10A, 10B);
(b) producing blind holes whose depth is less than the thickness of the support material by electrochemical etching into one surface (10A) of the support material, in such a way that the spacing of the blind holes provided in an otherwise essentially regular arrangement is locally modified to form inter-region transitions with an increased silicon wall thickness, wherein the thickness of the silicon walls between the inter-region transitions is configured to be greater than the thickness of the silicon walls inside the region by the amount of the increased blind-hole spacing;
(c) at least locally arranging a mask layer on the surface (10A) and the surface of the blind holes produced in step (b);
(d) eroding the support material at least as far as the bottom of the blind holes in order to obtain pores (11) which extend from one surface (10A) through to the opposite surface (10B) of the support material;
(e) removing the mask layer; and
(f) subjecting the support material obtained in step (e) to a thermal oxidation so that, as a function of the silicon wall thickness, the regions with thinner silicon walls are fully oxidized whereas the silicon walls are not fully oxidized in the inter-region transitions with an increased wall thickness, so that a silicon core is left remaining in the walls.

The silicon support material prepared in step (a) may, for example, be n-doped monocrystalline silicon (Si wafer). However, p-doped monocrystalline silicon may also be used.

In step (b) of the method, electrochemical etching is then carried out in the silicon. Such a method is known, for example, from EP 0 296 348, EP 0 645 621, WO 99/25026, DE 42 02 454, EP 0 553 465 or DE 198 20 756, to which reference is made in full scope and the disclosure of which is therefore intended to be part of the present invention. In the scope of such electrochemical etching, blind holes or pores with an aspect ratio of for example 1 to 300 or more may be etched in an essentially regular arrangement in silicon. Since, with suitably selected parameters, the electrochemical pore-etching method makes it possible to alter the pore spacing (pitch) within particular limits, the thickness of the resulting silicon walls can be locally varied by changing the pore spacing and/or omitting an entire row of pores in the otherwise regular arrangement of blind holes or pores. In this case, the pore-etching method may be carried out on the one hand whilst omitting pore rows or units and maintaining a consistently constant pitch spacing. On the other hand, it is also possible to provide two different pitch spacings, one for the respective compartments and another for the corresponding outer regions; also cf. FIG. 2(E). The abovementioned measures can be varied within narrow limits.

In order to obtain pores which pass through the support material or substrate (Si wafer) and are open on both surfaces (10A, 10B), silicon is eroded on the rear side of the Si wafer in steps (c), (d) and (e), for example by KOH etching, after having etched the blind holes, whereas the front side of the wafer and the inside of the blind holes or pores are protected by a mask layer, for example a silicon nitride layer produced by CVD deposition with a thickness of, for example, 100 nm. The mask layer may then be removed in step (e), for example by means of an HF treatment. Sputtering, laser ablation and/or polishing processes, for example a CMP process, are likewise suitable for the rear-side erosion of the Si wafer.

This produces a silicon wafer or silicon support material which is matricially provided with regular pores, the pores constituting through-tubes which connect the front and rear side of the wafer together.

The diameter of these pores may be enlarged or widened after their production, for example by etching in KOH. If Si(100) is used as a starting material, then essentially square pores are obtained by such etching owing to the crystal structure. For example, assuming a pore diameter of about 5 μm with a spacing of 12 μm between the mid-points of two pores (pitch) then, for example, the pore diameter can in this way be enlarged from 5 μm to 10 or 11 μm. The thickness of the silicon walls between the pores is increased to 2 or 1 μm at the same time. A square lattice of thin silicon walls is substantially obtained in this way. The depth of the pores, or the length of the silicon walls, in this case corresponds to the original thickness of the silicon wafer less the thickness of the Si layer eroded when opening the pores on the rear side.

In step (f), the lattice obtained in this way is converted into SiO₂ in a thermal oxidation process, for example at a temperature of 1050° C. and with a duration of 18 hours, by oxidation as a function of the pore-wall thickness in question. The structure of the substrate is essentially unchanged by this, apart from a volume increase of the wall regions due to the oxidation of Si to SiO₂.

If the mutual spacing of the blind holes or pores is increased periodically in step (b), for example every 5, 10 or 20 pores, for example by 1 μm, then this provides a superstructure which is composed of regions or compartments with arrays of pores (for example 5×5, 10×10, 20×20). The thickness of the silicon walls between these regions is greater than the thickness of the silicon walls inside the regions by the amount of the increased pore spacing. The regions with thin silicon walls will be fully oxidized to SiO₂ during the subsequent oxidation in step (f). But in the transitions between the regions, which have an increased wall thickness, the silicon walls are not completely oxidized so that a silicon core is left remaining in the walls, with the silicon core respectively merging into silicon dioxide over the cross section towards the outer side of the walls forming the frame. This provides locally completely fully transparent regions of SiO₂, which are completely separated from one another by non-transparent walls with the silicon core.

The application or binding of linker molecules may be carried out immediately after this. Such a linker molecules are not subject to any specific restriction, so long as they are capable of covalently binding to the OH groups present on the surface of the SiO₂ layer and furthermore have a functional group which is capable of covalently binding with capture molecules that can be used as probes in biological-chemical reactions. Such linker molecules are usually based on a silicon-organic compound. Such bifunctional silicon-organic compounds may, for example, be alkoxysilane compounds having one or more terminal functional groups selected from epoxy, glycidyl, chloro, mercapto or amino. The alkoxysilane compound is preferably a glycidoxyalkylalkoxysilane, for example 3-glycidoxypropyltrimethoxysilane, or an aminoalkylalkoxysilane, for example N-β-(aminoethyl) γ-aminopropyltrimethoxysilane. The length of the alkylene residue acting as a spacer between the functional group, for example epoxy or glycidoxy, which binds with the capture molecule or the probe, and the trialkoxysilane group is not subject to any restriction in this case. Such spacers may also be polyethylene glycol residues.

To complete the preparation of a biochip, capture molecules such as oligonucleotides or DNA molecules may then be bound or coupled to the support material via the linker molecules according to the standard methods of the prior art, for example by treating the porous substrate material, when epoxysilanes are used as linker molecules, by subsequent reaction of the terminal epoxide groups with terminal primary amino groups or thiol groups of oligonucleotides or DNA molecules which, in corresponding analysis methods, function as immobilized or fixed capture molecules for the target molecules present in the analyte to be studied. The oligonucleotides which can be used as capture molecules may, for example, in this case be prepared by using the synthesis strategy as described in Tet. Let. 22, 1981, pages 1859 to 1862. During the production method, the oligonucleotides may in this case be derivativized with terminal amino groups at either the 5 or 3 end position. Another way of binding such capture molecules to the inner-wall surfaces of the pores may be carried out by first treating the substrate with a chlorine source, for example Cl₂, SOCl₂, COCl₂ or (COCl)₂, optionally by using a radical initiator such as peroxides, azo compounds or Bu₃SnH and subsequently reacting it with a corresponding nucleophilic compound, in particular with oligonucleotides or DNA molecules which have terminal primary amino or thiol groups or other appropriate functional groups (see WO 00/33976).

The device according to the invention may fulfill the function of a 96-sample support with the density of a microarray. Microchip technologies available in the prior art can furthermore be parallelized on the basis of the device according to the invention.

The device according to the invention is also suitable in particular for the locally limited, light-controlled synthesis of molecules on the pore walls. The present invention therefore also relates to a method for controlling chemical or biochemical reactions or syntheses, comprising preparing a device or biochip according to the invention, introducing a synthesis substance into at least one of the pores of the support material, and shining light into the pores in order to optically excite at least the synthesis substance.

For planar substrates, the method of light-controlled synthesis is described, for example, in EP 0 619 321 and EP 0 476 014. Full reference is made to the disclosure of these documents in respect of the structure and light-controlled synthesis method so that, to this extent, these documents also form part to the disclosure of the present application. By propagating the light efficiently into the pores, it is possible to drive or control photochemical reactions on the pore walls. In particular, way complex sequential light-controlled photochemical reactions can in this be carried out on the pore boundary surfaces.

Optical crosstalk between the individual pores or regions/compartments is prevented by the reflective walls made essentially of silicon. The source a major problem with light-controlled synthesis on planar substrates.

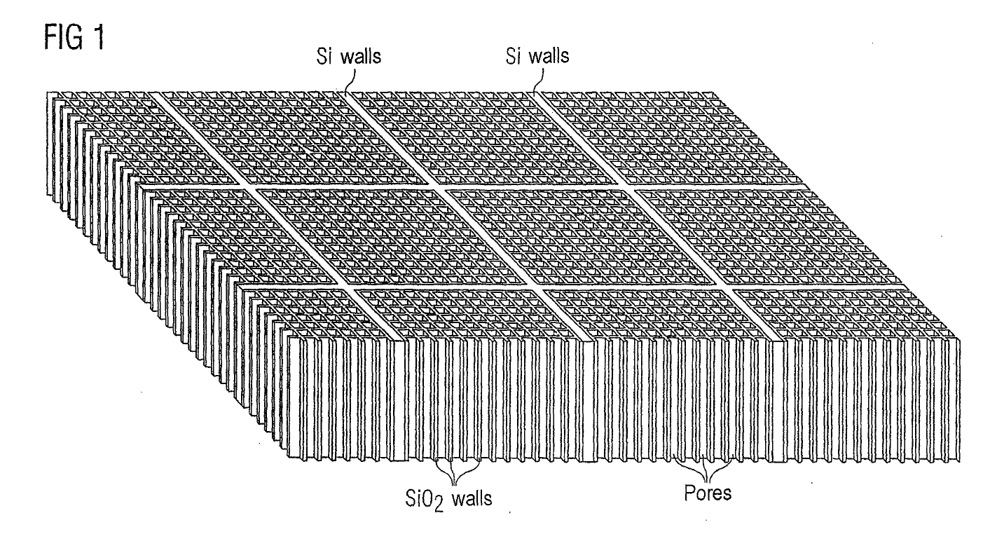

FIG. 1 shows a schematic view of a device which is presented in WO 03/089925 and has locally transparent regions made of SiO₂, said transparent regions in turn being surrounded by a reflective frame of walls with silicon core.

FIG. 2(A) shows a schematic view of a device (10) according to the invention, which has locally transparent regions (11A) of pores (11) with SiO₂ pore walls, each individual frame (12) of walls with a silicon core (12A) within the totality of all the frames of walls with a silicon core (12A) being spatially completely isolated from the frames surrounding it. FIG. 2(B) illustrates the definition with regard to the compartment aspect ratio, as specified above. FIG. 2(C) shows the plan view and FIG. 2(D) shows the side view of a detail from such a device. FIG. 2(E) schematically shows an exemplary “basic cell” of a structure with different pitch spacings within the compartment and in the outer region. The exemplary basic cell comprises 30×30 pores with a 24×24 pore array (pitch: 11.3 μm) within the compartment, in the outer region there being a pitch spacing of 12.0 μm (compartment wall thickness before oxidation: ˜10 μm (pore diameter: 10-11 μm); compartment wall thickness after oxidation: ˜5 μm).

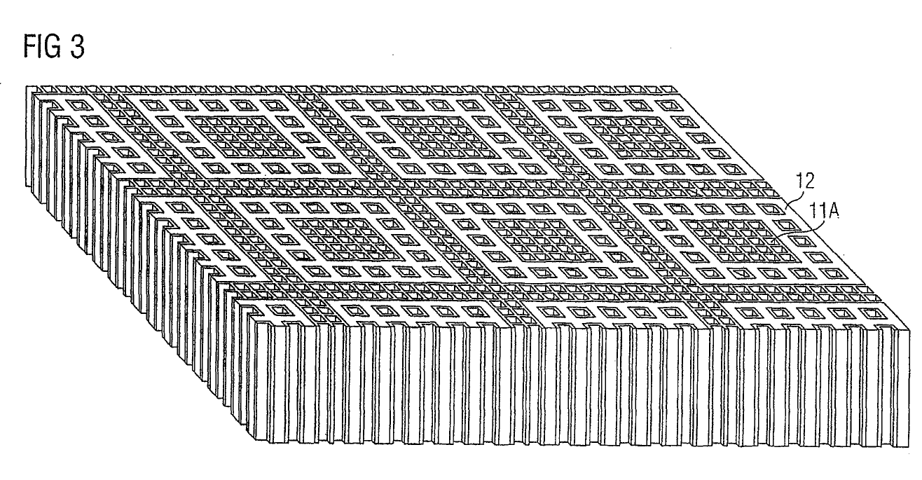

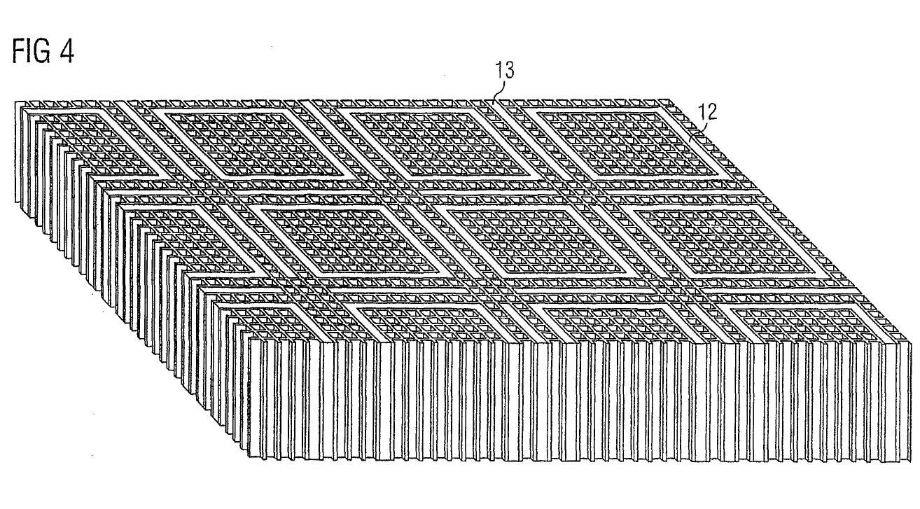

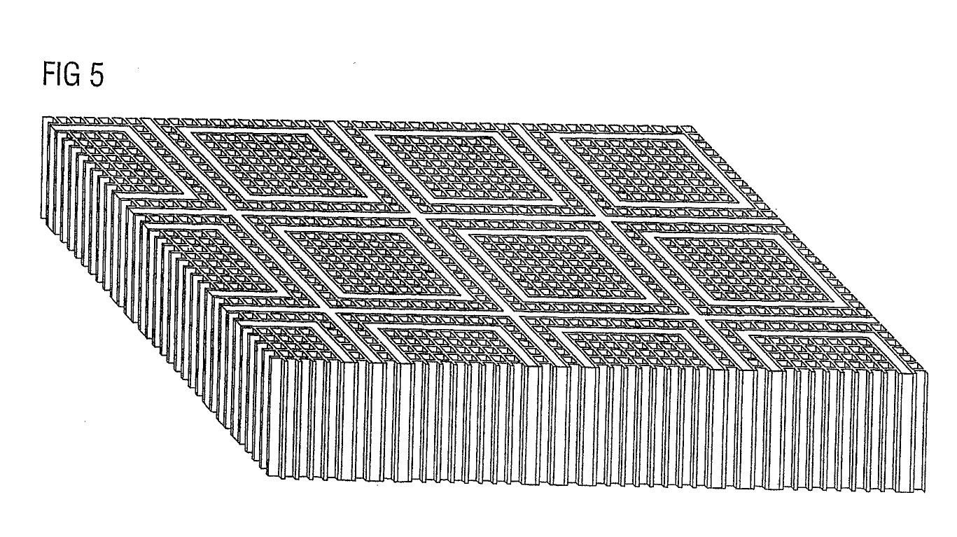

FIG. 3 and FIG. 4 show further embodiments of the device according to the invention, which are likewise distinguished by the fact that each individual frame (12) of walls with a silicon core (12A) within the totality of all the frames of walls with a silicon core (12) is spatially completely isolated from the frames surrounding it. The embodiment in accordance with FIG. 3 involves specific configuration of the frame made from walls with a silicon core. In the embodiment in accordance with FIG. 4, between the frames of walls with a silicon core which are spatially completely isolated from one another, provision is made in turn of webs (13) made of walls with a silicon core (12) which are spatially completely separated from these frames.

FIG. 5 shows a further embodiment of the device according to the invention, which represents a hybrid structure comprising continuous compartments and discontinuous compartments.

1-8. (canceled)

9. A device comprising:
a substantially flat silicon based macroporous support material, the support material having a first surface and a second surface opposite the first surface;
a plurality of pores in the support material, the pores having a diameter from about 500 nm to about 100 μm and extending from the first surface of the support material to the second surface of the support material; and
at least two regions, each region comprising:
at least one pore with SiO₂ pore walls;
a frame of walls surrounding the at least one pore with SiO₂ pore walls, wherein the walls have a silicon core and are arranged substantially parallel to a longitudinal axes of the pores, and the silicon core merges into silicon dioxide over a cross section towards an outer side of the walls forming the frame; and
at least one pore separating each frame from each region such that each of the frame of walls with a silicon core is spatially isolated from each other frame of walls with a silicon core.

10. The device according to claim 9, wherein the support material has a thickness between 100 to 1000 μm.

11. The device according to claim 10, wherein the support material has a thickness between 250 to 450 μm.

12. The device according to claim 9, wherein a pore density is in a range of from about 10⁴ to about 10⁸/cm².

13. The device according to claim 10, wherein a pore density is in a range of from about 10⁴ to about 10⁸/cm².

14. The device according to claim 9, wherein the pores with SiO₂ pore walls are substantially square and the frame of walls with a silicon core are substantially square or rectangular.

15. The device according to claim 12, wherein the pores with SiO₂ pore walls are substantially square and the frame of walls with a silicon core are substantially square or rectangular.

16. The device according to claim 9, wherein capture molecules selected from the group consisting of DNA, proteins, and ligands are covalently bound to at least one pore located within a frame.

17. The device according to claim 15, wherein the capture molecules are oligonucleotide probes.

18. The device according to claim 9, wherein the support material is n-doped monocrystalline silicon.

19. The device according to claim 9, wherein the support material is p-doped monocrystalline silicon.

20. The device of claim 9 adapted for use as a sample support for detecting biochemical reactions and/or bindings, study of enzymatic reactions, nucleic acid hybridizations, protein-protein interactions and protein-ligand interactions.

21. A method for controlling chemical or biochemical reactions or syntheses, comprising:
introducing a synthesis substance into at least one pore with SiO₂ pore walls being surrounded by a frame of walls, wherein the walls have a silicon core and are arranged substantially parallel to a longitudinal axis of the pore, and the silicon core merges into silicon dioxide over a cross section towards an outer side of the walls forming the frame, the frame of walls being separated from other frames of walls such that each of the frames of walls with a silicon core is spatially isolated from each of the other frames of walls; and
shining a light into the pore with SiO₂ pore walls in order to optically excite at least the synthesis substance.

22. A method of manufacturing a substantially flat silicon based macroporous support device, the method comprising:
(a) preparing a support material having a thickness made of silicon with a first surface and a second surface opposite the first surface;
(b) producing blind holes whose depth is less than the thickness of the support material by electrochemical etching into the first surface of the support material, in a substantially regular arrangement to form inter-region transitions with an increased silicon wall thickness, wherein a thickness of the silicon walls between the inter-region transitions is configured to be greater than the thickness of the silicon walls inside the region by the amount of the increased blind-hole spacing;
(c) depositing a mask layer on the first surface;
(d) eroding the support material at least as far as the bottom of the blind holes in order to obtain pores which extend from the first surface through to the second surface of the support material;
(e) removing the mask layer; and
(f) subjecting the support material obtained in step (e) to a thermal oxidation so that, as a function of the silicon wall thickness, regions with thinner silicon walls are fully oxidized whereas the silicon walls are not fully oxidized in inter-region transitions with an increased wall thickness, so that a silicon core is left remaining in the walls.

23. The method of manufacturing a substantially flat silicon based macroporous support device of claim 22, wherein the eroding is performed by KOH etching.

24. The method of manufacturing a substantially flat silicon based macroporous support device of claim 22, wherein the mask is a silicon nitride layer deposited by CVD deposition.

25. The method of manufacturing a substantially flat silicon based macroporous support device of claim 23, wherein the silicon nitride layer has a thickness of about 100 nm.

26. The method of manufacturing a substantially flat silicon based macroporous support device of claim 22, wherein the mask layer is removed by an HF treatment.
